(19) United States
(12) Patent Application Publication
(10) Pub. No.: US 2021/0185223 A1
(43) Pub. Date: Jun. 17, 2021

(54) METHOD AND CAMERA FOR PHOTOGRAPHIC RECORDING OF AN EAR

(71) Applicant: SIVANTOS PTE. LTD., SINGAPORE (SG)

(72) Inventor: THOMAS HEMPEL, ERLANGEN (DE)

(21) Appl. No.: 17/124,742

(22) Filed: Dec. 17, 2020

(30) Foreign Application Priority Data
Dec. 17, 2019 (DE) 102019219908.9

(51) Int. Cl. H04N 5/232; H04N 7/18; G06K 9/00; G06T 7/55; G06T 7/70

(52) U.S. Cl. CPC H04N 5/23222; H04N 7/188; G06K 9/00255; G06T 2207/30201; G06T 7/70; G06T 2207/30244; G06T 2207/10048; G06T 7/55

(57) ABSTRACT

For the recording of an ear of a user using a camera manually controlled by the user, the user is instructed to manually position the camera in a starting position to record his face. The face of the user is recorded by the camera. A need for correction of the starting position is ascertained based on the recording of the face and the user is instructed if necessary to change the starting position based on the need for correction. The user is instructed to move the camera manually into a target position, in which the camera is oriented to record the ear of the user. An estimated value for a current position of the camera is ascertained. A number of pictures is taken when the current position coincides with the target position, and an item of depth information about the ear of the user is derived from the pictures.

### CROSS-REFERENCE TO RELATED APPLICATION

This application claims the priority, under 35 U.S.C. § 119, of German patent application DE 10 2019 219 908, filed Dec. 17, 2019; the prior application is herewith incorporated by reference in its entirety.

### BACKGROUND OF THE INVENTION

### Field of the Invention

The invention relates to a method for photographic recording of an ear. Furthermore, the invention relates to a camera which is configured to carry out the method.

Knowing the anatomical properties of an ear of a specific person is advantageous in particular for the adaptation of hearing instruments, in particular hearing aid devices, referred to hereinafter as “hearing aids” for short. A person having a need for such a hearing aid typically finds a hearing aid acoustician or audiologist, who frequently performs an adaptation to the anatomy of the corresponding person after selection of a suitable hearing aid model. For example, in particular in the case of a hearing aid to be worn behind the ear, the length of an earpiece connecting means—for example a sound tube or a loudspeaker cable—is adapted to the size of the pinna or in particular a so-called ear mold is created for a hearing aid to be worn in the ear. A suitable size can also be selected for a corresponding earpiece (often also referred to as an “ear dome”).

To avoid the visit to the hearing aid acoustician and possibly also be able to avoid a comparatively complex and costly adaptation of a hearing aid by a hearing aid acoustician, a market has presently developed for hearing aids which are not adaptable or are only adaptable to a minor extent and also for adaptation via “remote maintenance”. In the latter case, a type of videoconference with a hearing aid acoustician is usually required, during which this acoustician can inspect the ear of the person, i.e., thus of the (future) hearing aid wearer. For example, it is known from published, European patent application EP 1 703 770 A1 that a hearing aid wearer creates an image of his ear using a camera and subsequently a hearing aid is shown simulated to him in this image in an intended wearing position on his ear. The correct seat of the hearing aid can also be checked on the basis of this image for the case that the hearing aid wearer is wearing a hearing aid.

### BRIEF SUMMARY OF THE INVENTION

The invention is based on the object of providing better options for adapting hearing aids.

This object is achieved according to the invention by a method having the features of the independent method claim. Furthermore, this object is achieved according to the invention by a camera having the features of the independent camera claim. Advantageous refinements and embodiments of the invention, which are partially inventive per se, are described in the dependent claims and the following description.

The method according to the invention is used for the photographic recording of an ear of a user—for example of a hearing aid wearer—using a camera manually guided by the user. According to the method, the user is initially instructed in this case to manually position the camera in a starting position to record his face (i.e. to move it into this starting position). This starting position is preferably aligned frontally with respect to the face of the user and can therefore also be referred to as a “selfie position”. By means of the camera, the face of the user is recorded in this starting position, preferably in that a photographic picture is taken of the face. In dependence on the picture of the face, a need for correction for the starting position is ascertained and if necessary—i.e. if a need for correction exists—the user is instructed to change the starting position in dependence on the need for correction. In other words, it is ascertained on the basis of the recorded face whether the camera is correctly oriented (in particular as intended) in relation to the face of the user in its starting position. Subsequently, the user is instructed to move the camera manually—preferably along a predetermined path, for example approximately a circular path, by guiding the camera with outstretched arm—into a target position, in which the camera is oriented for the picture of the ear of the user. Preferably while the user moves the camera into the target position, an estimated value for a current position of the camera is then ascertained and when the current position coincides with the target position, a number of photographic pictures is triggered. An item of depth information about the ear of the user is subsequently derived on the basis of this number of photographic pictures.

A type of 3D map of the ear of the user is thus preferably created from the photographic pictures.

The above-described method enables a user, for example for the adaptation of a hearing aid in a simple manner, to create photographic pictures which highly probably also depict his ear, without the user triggering the pictures himself and also having to orient the camera himself at the same time. In addition, a high level of information content which results from the depth information is enabled in a correspondingly simple manner.

In an expedient method variant, the estimated value for the current position of the camera is ascertained by means of positioning sensors which are associated with the camera. Acceleration sensors and/or comparable sensors, for example gyroscopic sensors, are preferably used as such positioning sensors. In this case, the estimated value is preferably determined starting from the starting position on the basis of a position change detectable by means of such sensors. For example, multiple different sensors can also be combined to form an inertial measurement system. For example, an Earth's magnetic field sensor can also be used for absolute position determination.

In one preferred refinement of the above-described method variant, if an approximation of the current position to the target position is ascertained on the basis of the estimated value, a number of photographic pictures is triggered by means of the camera and this number of pictures is analyzed as to whether the ear of the user is included in the or at least one of the possibly multiple pictures. If the latter is the case, it is presumed in particular that the target position is reached and the above-described number of photographic pictures is triggered.

In an expedient continuation of the above-described refinement, the number of pictures is analyzed, in particular to determine whether the target position is reached, as to whether the camera is oriented with its optical axis essentially (optionally approximately or exactly) perpendicularly to a sagittal plane and at the same time is in particular also arranged located in a frontal plane intersecting the ear of the user. However, a range which is offset by up to 10° ventrally or dorsally in relation to the frontal plane can also be assumed as the target position in this case. This can be expedient, for example, to generate the depth information from multiple pictures located at an angle to one another.

In an alternative or optionally also additional method variant, during the movement of the camera in the direction toward the target position, photographic pictures are triggered by means of the camera and these pictures are analyzed as to whether the ear of the user is contained in the pictures. In this case, the estimated value for the current position of the camera is thus ascertained “optically”, in particular by means of image recognition methods. Reaching the target position is detected in this case similarly to the above-described method variants or refinements, namely when the ear is included in at least one of the pictures and it can preferably also be detected that the optical axis of the camera is oriented as described above.

In one preferred method variant, a smartphone is used as the camera which contains at least one camera, preferably at least one front camera. The instructions to the user for orienting and moving the camera are preferably output in this case acoustically and/or by means of the display screen of the smartphone.

Preferably, when the target position of the camera is reached, the user is instructed to hold the camera in this position or possibly to move it slightly in the above-described target range of the target position—preferably with output of corresponding instructions.

In one expedient method variant—preferably in addition to the visible spectral range—at least a component of the infrared spectrum, in particular the near-infrared spectral range, is recorded and used to create the depth information in the number of the pictures of the ear. The corresponding component of the infrared spectrum is optionally recorded here by means of the same sensor. Alternatively, the corresponding component of the spectrum is recorded using an additional sensor, which preferably is designed exclusively to record this component. For example, the depth information can be derived by evaluating the respective focal positions of the visible spectral range and the infrared spectrum.

In a further expedient method variant, in addition to the depth information, items of geometrical size information about the ear are also derived from the number of the pictures of the ear. For example, in this case a diameter of the auditory canal, a size of the pinna, the helix, the antihelix, the tragus, and/or the antitragus is ascertained. This is carried out in particular by feature extraction from the picture or the respective picture. Such a feature extraction is known, for example from Anwar A S, Ghany K K, Elmandy H (2015), Human ear recognition using geometrical features extraction, Procedia Comput Sci 65:529-537.

In one expedient method variant, the number of the pictures of the ear, the depth information, and/or items of size information are subsequently transmitted to a hearing aid data service. This hearing aid data service is, for example, a database of a hearing aid acoustician, audiologist, and/or hearing aid producer, at which the corresponding data are at least temporarily stored and are used, for example, for possible later analysis by the hearing aid acoustician, in particular for adapting a hearing aid.

In one expedient method variant, in particular for the case in which multiple pictures of the ear are taken, one picture is selected automatically or by selection by the user and used for the transmission and/or analysis.

In an optional method variant, at least one of the pictures is used to have the seat of a hearing aid (worn during the picture) on the ear checked by a corresponding specialist, in particular the hearing aid acoustician, after transmission of the corresponding data.

Furthermore, a color matching of a hearing aid to be adapted to the user can also optionally be carried out on the basis of the images. A simulation of a hearing aid in the worn state on the ear of the user can also expediently be displayed, so that the user can himself form an image of his appearance with hearing aid.

The camera according to the invention, which is preferably the above-described smartphone, contains a control unit which is configured to carry out the above-described method automatically, in particular in interaction with the user.

The above-described positioning sensors are preferably part of the camera, in particular of the smartphone itself, in this case.

In one expedient embodiment, the control unit (also referred to as a “controller”) is formed at least in essence by a microcontroller having a processor and a data memory, in which the functionality for carrying out the method according to the invention is implemented by programming in the form of operating software (firmware or application, for example a smartphone app), so that the method—in particular in interaction with the user—is carried out automatically upon execution of the operating software in the microcontroller. In principle, the controller can also alternatively be formed in the scope of the invention by a non-programmable electronic component, for example an ASIC, in which the functionality for carrying out the method according to the invention is implemented using circuitry means.

The conjunction “and/or” is to be understood here and in the following in particular in such a way that the features linked by means of this conjunction can be formed both jointly and also as alternatives to one another.

An exemplary embodiment of the invention is explained in greater detail hereinafter on the basis of a drawing.

Other features which are considered as characteristic for the invention are set forth in the appended claims.

Although the invention is illustrated and described herein as embodied in a method for photographic recording of an ear, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a schematic flow chart of a sequence of a method for photographic recording of an ear of a user by means of a manually-controlled camera;

FIG. 2 is a schematic illustration of the camera in a starting position;

FIG. 3 is a schematic illustration of the camera during a movement to a target position;

FIG. 4 is a schematic illustration of the camera in a target position during the photographic recording of the ear; and

FIG. 5 is a schematic illustration of a feature extraction which is carried out on a photographic picture of the ear.

### DETAILED DESCRIPTION OF THE INVENTION

Parts corresponding to one another are always provided with the same reference signs in all figures.

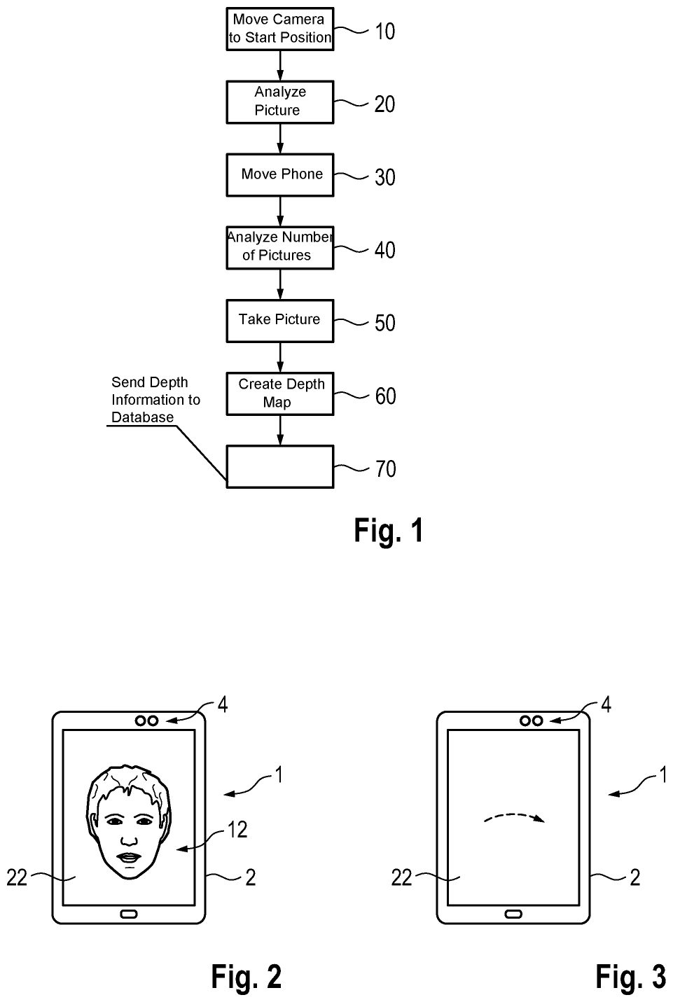

Referring now to the figures of the drawings in detail and first, particularly to FIG. 1 thereof, there is shown a method for photographically recording an ear of a user by means of a camera 1 shown in FIGS. 2-4. The camera 1 is formed here by a smartphone 2 having a front camera 4 (or: “selfie camera”)—containing two (image) sensors in the illustrated exemplary embodiment. At the beginning of the method—upon a start of a corresponding app executing the method by the user—in a first method step 10, the user is instructed—specifically via an acoustically output command—to move the camera 1 into a starting position. The starting position is predetermined in this case in such a way that the user can create a frontal picture of his face 12. The starting position is therefore also referred to as the “selfie position”.

In a second method step 20, the smartphone 2 analyzes a picture of the face 12 created by means of the front camera 4 and ascertains therefrom whether there is a need for correction with respect to the starting position, for example whether the user should hold the smartphone 2 somewhat higher, further to the left, or further to the right. If this is the case, the smartphone 2 outputs a corresponding instruction acoustically, optionally also by corresponding display on a display or display screen 22 of the smartphone 2.

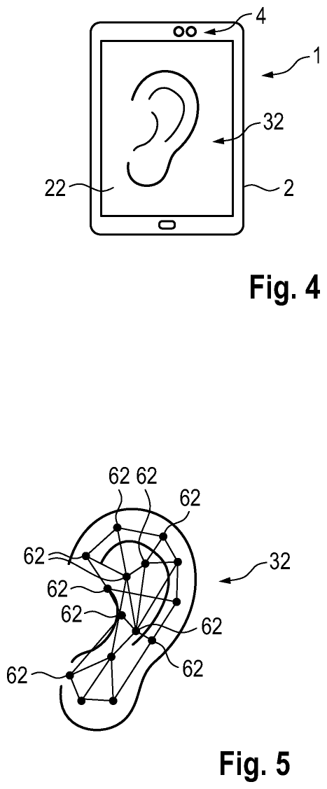

In a following method step 30, the smartphone 2 instructs the user to move the smartphone 2 on the outstretched arm (to record, for example, the right ear 32; see FIG. 4) in a circular movement to the right (see FIG. 3). The smartphone 2 monitors by means of its—typically provided—positioning sensors, for example acceleration sensors, whether the movement is moved “correctly”, i.e. without undesired deviations of the smartphone 2 from a theoretical movement curve downward or upward. On the basis of these positioning sensors, the smartphone 2 thus ascertains an estimated value of a current position of the smartphone 2 in relation to the head of the user. If the current position of the smartphone 2 approaches a target position, which is predetermined in such a way that a photographic recording of the right ear 32 is possible, the smartphone 2 triggers a number of pictures by the front camera 4.

In a further method step 40, the smartphone 2 analyzes the number of pictures by means of an image recognition method as to whether the right ear 32 is included in one, specifically at least the last picture. If the smartphone 2 recognizes the ear 32, the smartphone 2 analyzes whether a desired recording angle is reached, for example whether the optical axis of the front camera 4 is oriented, for example located in a frontal plane, thus “looking” frontally at the ear 32. This orientation is characteristic for the target position of the smartphone 2.

If the smartphone 2 recognizes that it is arranged in the target position, in a method step 50, it instructs the user to hold the smartphone 2 still and triggers the front camera 4 to record at least one, preferably multiple images of the ear 32 (cf. FIG. 4).

The front camera 4 is also designed to record near-infrared radiation and, in a following method step 60, uses the recorded near-infrared radiation to create a depth map of the ear 32. In addition, the smartphone 2 executes a feature extraction, shown in greater detail in FIG. 5, on at least one of the images of the ear 32. In this case, the smartphone 2 identifies multiple significant points 62 on the ear 32 and uses them to obtain items of size information about the ear 32.

In a following method step 70, the images of the ear 32, the depth information, and the items of size information are sent to a hearing aid data service, for example to a database of a hearing aid acoustician.

The subject matter of the invention is not restricted to the above-described exemplary embodiment. Rather, further embodiments of the invention can be derived by a person skilled in the art from the above description.

The following is a summary list of reference numerals and the corresponding structure used in the above description of the invention:

1. camera

2. smartphone

4. front camera

10. method step

12. face

20. method step

22. display screen

30. method step

32. ear

40. method step

50. method step

60. method step

62. point

70. method step

1. A method for photographic recording of an ear of a user using a camera manually controlled by the user, which comprises the steps of:
instructing the user to manually position the camera in a starting position to record a face of the user;
recording the face of the user by means of the camera;
ascertaining a need for correction for the starting position in dependence on the recording of the face;
instructing the user if necessary to change the starting position in dependence on the need for correction;
instructing the user to move the camera manually into a target position, in which the camera is oriented to record the ear of the user;
ascertaining an estimated value for a current position of the camera;
triggering a number of photographic pictures when the current position coincides with the target position; and
deriving an item of depth information about the ear of the user on a basis of the number of photographic pictures.

2. The method according to claim 1, which further comprises ascertaining the estimated value for the current position of the camera by means of positioning sensors associated with the camera.

3. The method according to claim 2, wherein, when an approach of the current position to the target position is ascertained on a basis of the estimated value, triggering a number of photographic pictures by means of the camera and the number of photographic pictures is analyzed as to whether the ear of the user is included in at least one picture.

4. The method according to claim 3, which further comprises analyzing the number of photographic pictures as to whether the camera is oriented with its optical axis generally perpendicular to a sagittal plane.

5. The method according to claim 1, wherein during a movement of the camera in a direction toward the target position, taking the photographic pictures by means of the camera and the photographic pictures are analyzed as to whether the ear of the user is contained in the photographic pictures.

6. The method according to claim 1, which further comprises using a smartphone having at least one camera as the camera.

7. The method according to claim 1, which further comprises recording at least a component of an infrared spectrum recorded by means of the camera and is used to create the item of depth information in the number of photographic pictures of the ear.

8. The method according to claim 1, which further comprises deriving items of geometrical size information about the ear from the number of photographic pictures of the ear.

9. The method according to claim 1, which further comprises transmitting the number of photographic pictures of the ear, the item of depth information, and/or items of size information to a hearing aid data service.

10. The method according to claim 2, wherein the positioning sensors are acceleration sensors.

11. The method according to claim 4, which further comprises analyzing the number of photographic pictures as to whether the camera is oriented with the optical axis disposed in a frontal plane intersecting the ear of the user.

12. The method according to claim 7, wherein the infrared spectrum is a near-infrared spectral range.

13. A camera, comprising:
a controller programmed to carry out a method for photographic recording of an ear of a user using the camera manually controlled by the user, which comprises the steps of:
instructing the user to manually position the camera in a starting position to record a face of the user;
recording the face of the user by means of the camera;
ascertaining a need for correction for the starting position in dependence on the recording of the face;
instructing the user if necessary to change the starting position in dependence on the need for correction;
instructing the user to move the camera manually into a target position, in which the camera is oriented to record the ear of the user;
ascertaining an estimated value for a current position of the camera;
triggering a number of photographic pictures when the current position coincides with the target position; and
deriving an item of depth information about the ear of the user on a basis of the number of photographic pictures.
